(19) United States
(12) Patent Application Publication
(10) Pub. No.: US 2006/0001205 A1
(43) Pub. Date: Jan. 5, 2006

(54) Jounce bumper

(76) Inventor: Irfan Raza, Troy, MI (US)

Correspondence Address: Peter N. Lalos;STEVENS DAVIS MILLER & MOSHER, LLP, Suite 850, 1615 L Street NW, Washington, DC, 20036, US

(21) Appl. No.: 10/879,729

(22) Filed: Jun. 30, 2004

(51) Int. Cl. F16F 3/08

(52) U.S. Cl. 267/152

(57) ABSTRACT

An energy absorption device for providing a softer stop arrangement between a pair of components. A bumper is provided with a cylindrical insert mounted therein. Upon application of force between the components, the compressible bumper collapses around the insert and outward. The insert prevents the bumper from expansion inward of the bumper to limit the amount the bumper compresses and further is made of a flexible material to absorb energy. The combination of the bumper and the insert provides a definite stop to the bumper assembly. The device is usable between any two components to prevent collisions between the components up to a certain force between them and is also usable between a strut assembly and a vehicle suspension to prevent the strut assembly from bottoming out.

This invention relates to a jounce bumper for motor vehicle suspensions systems either in the strut assemblies or other locations.

### BACKGROUND OF INVENTION

Microcellular urethane bumpers are used in vehicle suspensions to absorb energy during jounce and to act as a supplemental spring. The bumper 100 has a general appearance as shown in FIG. 1. These could be mounted on a strut assembly, as shown in the U.S. Pat. No. 5,487,535, where the bumper surrounds the piston rod of the strut. A hole 110 through bumper 100 allows for passage of the piston rod. This bumper prevents the cylinder of the strut assembly from impacting heavily the mounting assembly. The bumpers could also be mounted in other locations, as shown in U.S. Pat. No. 5,725,203, where the bumper is free standing to prevent a control arm of the suspension from impacting with the vehicle frame.

Bumpers can be mounted in a free state or within a rigid cup, as shown in U.S. Pat. No. 6,158,726, which discloses a bumper with the use of a rigid cup attached. An example of a rigid cup is shown in FIG. 2, and is identified as rigid cup 200. The operation of a rigid cup assembly is shown in FIGS. 3A-3C, illustrating a bumper assembly 350. The rigid cup 310, shown here with a lip 311, acts to attach the bumper 100 to the vehicle or the strut (not shown) and limits the bumper distortion, thereby increasing its rate. A force, provided by a rod or other device 220, acts upon the bumper assembly 350 in the direction F, as shown in FIG. 3B. The force necessary to compress the bumper assembly 350 increases as the bumper is compressed and the bumper absorbs energy as it is compressing. As the bumper 100 is compressed, the resistance to compression increases to the point where the bumper acts as a solid, and transfers the remaining energy from the impact to the vehicle. Such state is illustrated in FIG. 3C. The use of a rigid cup or another constraint limits the bulging of the bumper, thereby reducing the amount of travel needed to reach the point where the bumper becomes a solid.

In general, when more energy must be removed, a larger bumper is used. Recent styling trends are dictating the use of low profile tires, which in effect removes an important energy management element. To counteract the loss of the cushioning given by higher profile tires, the jounce bumpers must absorb much greater amounts of energy. In most cases, there is not enough space to package a bumper large enough to absorb the amount of energy experience during an impact.

To absorb this energy effectively, other designs have sought to modify the bumper cup whereby the jounce bumper is placed into an elastic cup. Such is disclosed in U.S. Pat. No. 6,485,008, which is incorporated by reference herein in its entirety. In such jounce bumper assembly, the bumper compresses into an elastic bumper cup, rather than the metal cup noted above. The bumper assembly is located between two objects, for example, a strut and suspension component. When a force compresses the bumper assembly, the bumper begins to compress into the bumper cup. As the force increases, the amount that bumper is compressed into bumper cup increases. In response to this increase, the bumper cup begins to expand outward at its rim portion. This combination of compression and expansion allows the bumper cup assembly to absorb more energy and the bumper assembly to be compressed into a smaller space than the rigid bumper cup designs. However, a problem with such bumper cup assemblies is that they do not provide a positive stop to the system.

### SUMMARY OF INVENTION

One object of the invention is to provide a bumper assembly that overcomes the limiting effect a rigid cup has on a bumper assembly and overcomes the non-limiting effect of an elastic cup. Another object of the invention is to provide a compact bumper assembly capable of absorbing a larger amount of energy than a similar sized bumper assembly while at the same time providing a positive stop to the assembly.

These and other problems are overcome with a bumper assembly comprising a microcellular urethane (MCU) jounce bumper having a thermoplastic urethane (TPU) cylinder mounted therein. The MCU bumper in general has a hole along its longitudinal axis. The cylindrical TPU cylinder insert has an internal diameter the same size as the hole through the MCU bumper, an outer diameter smaller than the outer diameter of the MCU bumper, and an annular flange. The TPU insert is then mounted or molded inside the MCU bumper so that the central diameter and the hold of the MCU bumper are collinear and the insert abuts a bottom surface of the MCU bumper. As a force acts on the bumper assembly along its longitudinal axis, it begins to collapse and push slightly outward and inward. The insert will limit inward movement of the bumper, however, the flexibility of the thermoplastic urethane will allow the insert to move a little as a result of the movement inward and absorb a portion of the energy. As a result of the combination insert and bumper, the bumper assembly will be able to absorb more energy than a convention bumper while at the same time providing a positive stop to the bumper assembly.

In an alternative embodiment, the bumper with the insert is partially placed within a TPU cup attached to a surface of either a strut assembly or free standing in another assembly to increase the rate of the bumper. As a force acts upon the bumper, it begins to press into the TPU cup. Upon an increasing force being applied, the TPU cup begins to expand outwardly at its opening at the same time the bumper compresses within the TPU cup. Similarly to the previous embodiment, the insert will limit inward movement of the bumper, however, the flexibility of the thermoplastic urethane will allow the insert to move a little as a result of the movement inward and absorb a portion of the energy. Thus, the combination of the bumper, the insert and the cup act in unison to receive the force, and allow more travel of the strut assembly as the cup expands. As a result, the bumper assembly is capable of absorbing an increased amount of energy in a compact area while still allowing more travel of the strut assembly and providing a positive stop.

As a third embodiment of the invention, a rigid cup is used in place of the TPU cup. Such an assembly operates in a similar manner to the TPU cup, but does not expand radially on increase forces. The rigid cup also increases the rate of the bumper more than the TPU cup and provides a more definite stop.

### BRIEF DESCRIPTION OF THE DRAWINGS

A preferred embodiment of the invention will now be described with reference to the accompanying drawings, in which:

FIG. 1 is a perspective view of a bumper;

FIG. 2 is a perspective view of a bumper cup;

FIGS. 3A, 3B and 3C illustrate the operation of a prior art bumper using a rigid cup;

FIG. 4A illustrates a thermoplastic insert according to a first embodiment of the invention;

FIG. 4B illustrates a bumper according to the first embodiment of the invention;

FIG. 5 illustrates a bumper assembly according to the first embodiment of the invention;

FIG. 6 illustrates a blown up view of a second embodiment of the invention;

FIGS. 7A-7C illustrate the operation of the first embodiment of the bumper assembly according to the invention;

FIGS. 8A-8C illustrate the operation of the second embodiment of the bumper assembly according to the invention;

FIGS. 9A-9D illustrate a mold and process for making a bumper assembly according to the invention; and

FIG. 10 illustrates a graphical comparison of the bumper assemblies according to the present invention with a prior art bumper assembly.

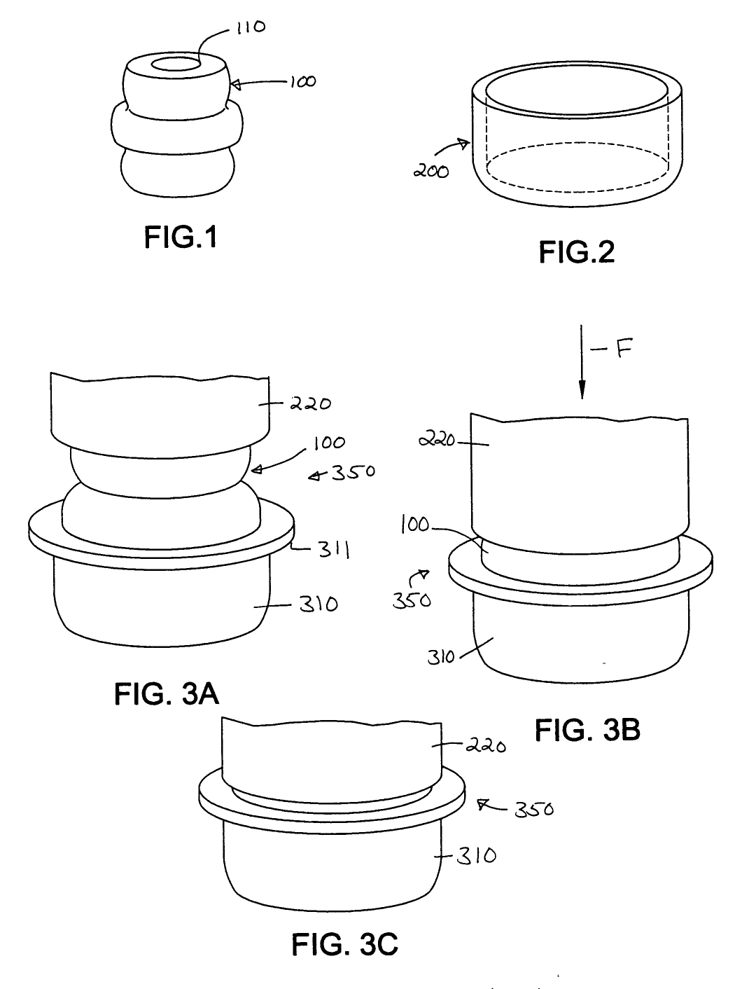

### DETAILED DESCRIPTION OF THE PREFERRED EMBODIMENT

When the vehicle travels over a bump, a strut assembly collapses to absorb the shock. Upon incurring a force greater than the force the strut can handle, the strut will bottom out, or completely collapse. Bumper assemblies provide a cushion between the cylinder of the strut and the surface to which the strut is attached. In some strut assemblies, a rigid cup is used to mount the bumper, as shown in FIGS. 3A, 3B and 3C. However, these assemblies do not allow for maximum energy absorption and maximum distance travel. On the other hand, dispensing with the rigid cup or using a flexible cup, while providing increased energy absorption and distance travel, does not provide the system with a definite stop. Accordingly, the preferred embodiments of this invention provide a bumper assembly with the energy absorption and distance travel of the flexible cup or no cup along with the definite stop of the rigid cup.

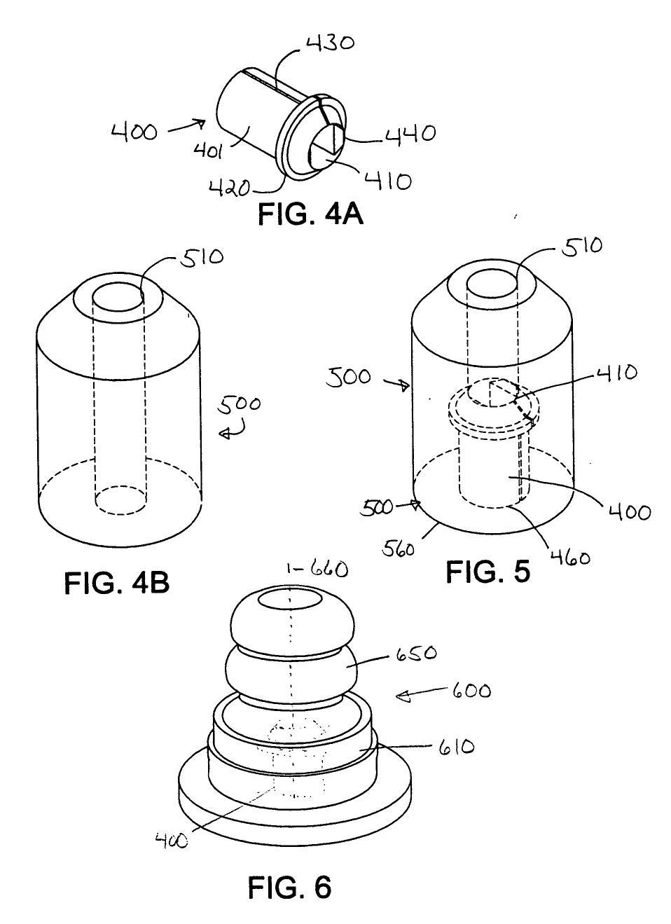

A parts view of the jounce bumper assembly according to a first embodiment of the invention is shown in FIGS. 4A and 4B and the assembled view is shown in FIG. 5. The same reference numerals will be used for the same parts in different views. The insert is shown in FIG. 4A. As shown, the insert 400 generally comprises a cylindrical shape having a longitudinal hole 410 that has a diameter D along its length thereof. An annular flange portion 420 is provided around the outer surface 401 of the insert 400. The flange 420 is shown near an upper side 440, however, it may be at any position along the length of the insert 400. Its use and operation will be described below. The insert 400 may also have a slit 430 along its length thereof to allow for expansion of the diameter of the hole 410. The insert 400 may also have flat sides 450 along the inner surface of the hole 410, which can be used in operation to prevent the insert from rotating about a shaft on which it may be mounted. However, these surfaces may be dispensed with if required.

The insert is made of a thermoplastic urethane (TPU), a material well known for its rigidity while simultaneously being flexible. Examples of formulations of TPU materials are available from U.S. Farathane Corporation, located in Sterling Heights, Michigan. The insert 400 can be made by any of a number of processes, such as extrusion molding, plastic injection molding or the like.

The bumper 500 is shown in detail in FIG. 4B. It generally has a cylindrical shape along a length thereof and can comprise a hole 510 through the center thereof. If the bumper 500 is placed in a strut assembly, the piston rod of the strut would pass through hole 510 with the bumper operating to prevent the strut from bottoming out against a suspension component. The bumper 500 may be made of any compressible material that can absorb energy and return to its original shape after such absorption.

Preferably the bumper 500 is made of a microcellular urethane (MCU) and can be made from a process of molding, extrusion and the like. The microcellular urethane can be made by combining a prepolymer and a polyal in a manner known to those having skill in the art. An example of such a microcellular urethane combination is an AUTOTHANE 5000 prepolymer combined with an AUTOTHANE A5505 polyal, sold by Hyperlast Limited of Derbyshire, United Kingdom. Such components are combined in a manner known in the art to form the microcellular urethane.

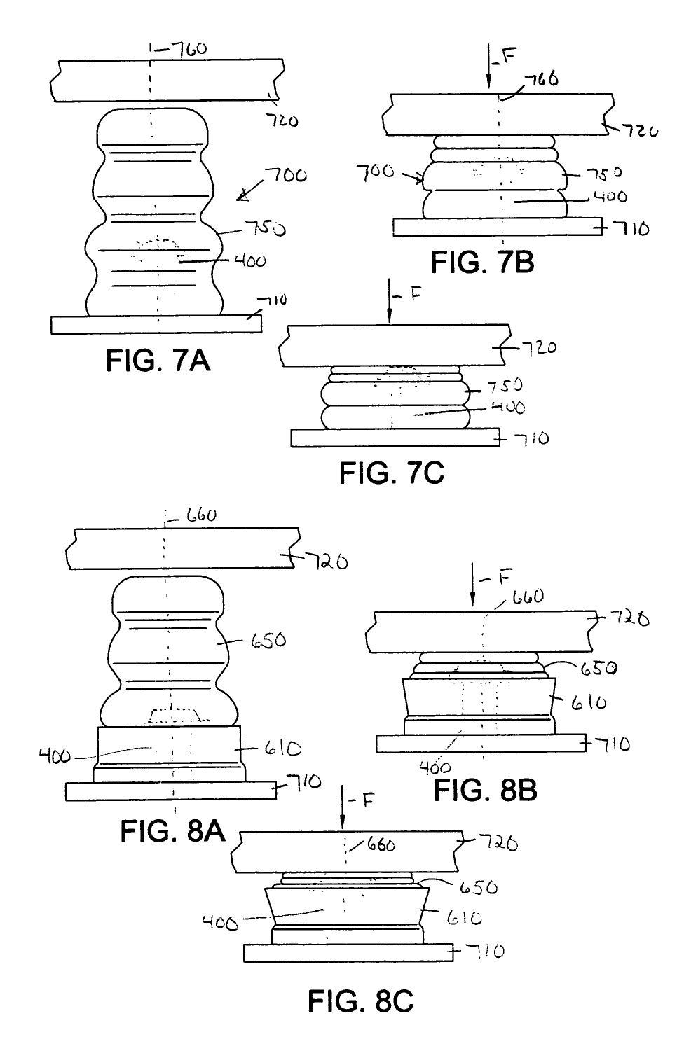

Bumpers, such as bumper 500, have a variety of shapes. In FIGS. 4B and 5, bumper 500 is a simple cylinder with a taper on one end, however, the bumpers 650 shown in FIGS. 6 and 750 shown in FIG. 7 have annular bumps. It should be noted that the specific design or shape for any bumper depends on the particular needs, compression requirements and design of the bumper assembly.

FIG. 5 illustrates the preferred embodiment of a bumper assembly 580. The bumper assembly 580 has the bumper 500 with the insert 400 mounted or formed therein. The hole 410 of the insert 400 is aligned with the hole 510 of the bumper 500 so that each is collinear. Such alignment allows for the passage of a piston rod for a strut assembly if necessary. The insert 400 is generally placed at the lower side 560 of the bumper 500 to allow for maximum compression of the bumper from the opposite end of the bumper assembly 580. The flange 420 operates when the bumper 500 has insert 400 mounted therein to prevent movement of the insert along the longitudinal direction of the hole 10.

The operation of the bumper assembly 700 is shown in detail in FIGS. 7A-7C. The bumper assembly 700 has a bumper 750 with an insert 400 mounted therein. The bumper assembly 700 is placed between a pair of objects 710 and 720 which in operation move with respect to each other. Such objects may be parts of a suspension that may collide with each other during shocks moving through the system. The bumper assembly 700 is placed between objects 710 and 720 to prevent collisions between them. When a force in a direction F does act on object 720, as shown in FIG. 7B, it begins to move towards object 710, compressing bumper assembly 700 therebetween. Bumper 750 begins to compress, and to expand slightly outward from its longitudinal axis 760. Bumper 750 also begins to expand inward towards its longitudinal axis 760, creating pressure against insert 400. Because of its flexibility, the insert 400 will compress slightly but will resist much of the pressure from the bumper 750. As the force in the direction increases, as shown in FIG. 7C, bumper 750 nearly fully compresses, reaching a maximum expansion away from the longitudinal axis 760 and maximum compression around the insert 400.

A second embodiment of a bumper assembly 600 according to the invention is shown in FIG. 6, wherein the combination of a bumper 650 having an insert 400 mounted therein is partially inserted into a cup 610. The cup may be either a metal or a plastic cup. For purposes of this embodiment a thermoplastic urethane (TPU) cup was used. Such material is well known as described above. The cup 610 generally has a cavity 611 along its central axis for receiving a portion of the bumper 650, as shown.

The placement of bumper assembly 600 between objects 710 and 720, as shown in FIG. 8A, provides similar actions, but different results because of the cup 610. As shown in FIG. 8B, a force acts upon object 720 in the direction F towards object 710. This begins to compress bumper 650 into the cavity 611 of the cup 610. As the force continually compresses the bumper 650, the bumper begins to expand slightly outward from its longitudinal axis 660 and inward toward the axis. As the bumper 650 compresses around the insert 400 embedded inside the bumper, the insert will compress slightly because of its flexibility, but will otherwise resist the inward expansion of the bumper. Conversely, as the bumper begins to expand outwardly, the pressure begins to expand the cup 610 radially at its rim 612 in the direction W. The rigidity of the TPU in conjunction with the flexibility, as noted above, reduces the outward expansion of the bumper 650. Thus, the insert 400 and cup 610 absorb some of the energy that would otherwise be absorbed by the bumper 650 and thus the combination reduces the overall compression of the bumper assembly 600, in comparison with the bumper assembly 700 with no cup.

As a third embodiment to that shown in FIGS. 6, 8A-C, the cup could be made of metal or a non-flexible plastic or other material. This would have the effect of completely resisting the outward expansion of the bumper 650, but would otherwise operate in a similar manner. The reduction in the outward expansion of the bumper 650 as a result of the rigid cup and the use of the insert 400 has the effect of reducing the overall compression of the bumper assembly in comparison with the bumper assembly 650 having a flexible cup 610.

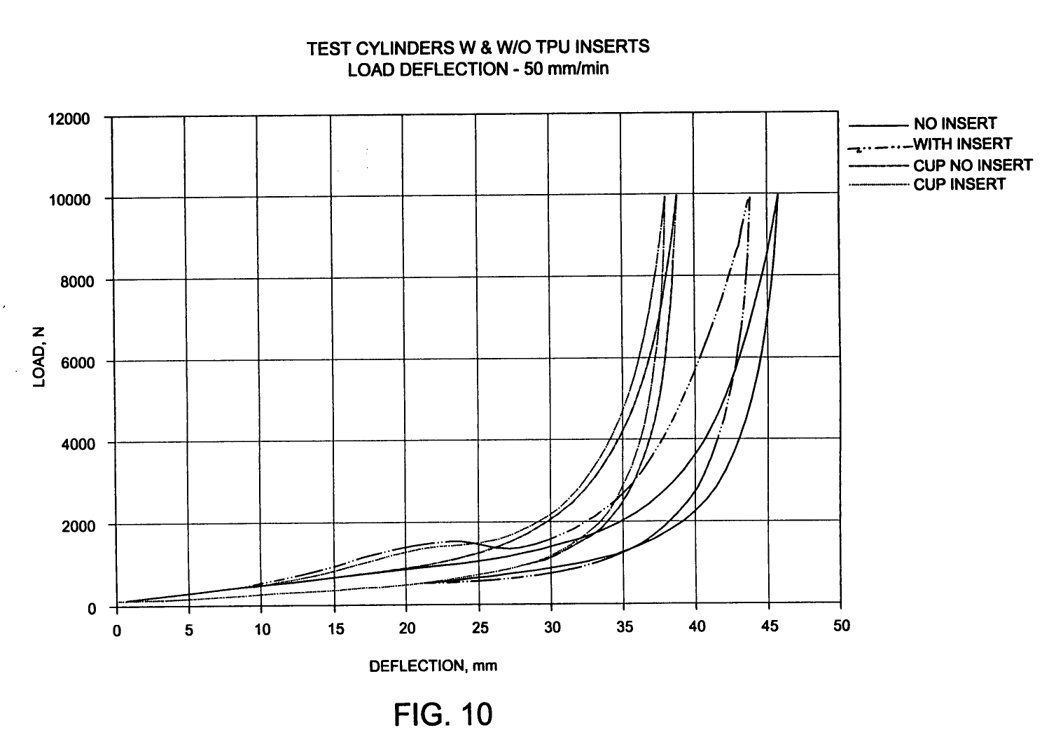

A comparison of various combinations of bumpers, inserts and cups is illustrated in FIG. 10. The graph shows a how much the bumper assembly will compress under a force of 10,000N. Four bumper assemblies were compared, a bumper with no insert, a bumper with an insert, a bumper mounted inside a rigid cup and a bumper with an insert mounted inside the cup. For each assembly, a similar bumper was used, as well as a similar insert and similar cup.

As shown in the graph, a bumper with no insert deflected the most under the 10KN compression, nearly 47 mm. Mounting an insert according to the present invention reduced the compression under the same force to about 43.5 mm. Placing the insertless bumper into a cup reduced the compression under the same force to about 38.5 mm and mounting the insert into the bumper in the cup reduced the compression to about 37 mm. Thus, an insert in either situation allows either bumper assembly, i.e., in a rigid cup or not, to absorb the same energy, but allows such absorption to occur in a smaller space. Thus, if a rigid stop is needed for a bumper assembly at a certain space, a selection of a particular insert mounted into the bumper would provide an assembly having a particular compression distance, in comparison to a bumper assembly without an insert. The use of a rigid or flexible cup would add to the tailoring of the bumper assembly to the particular application.

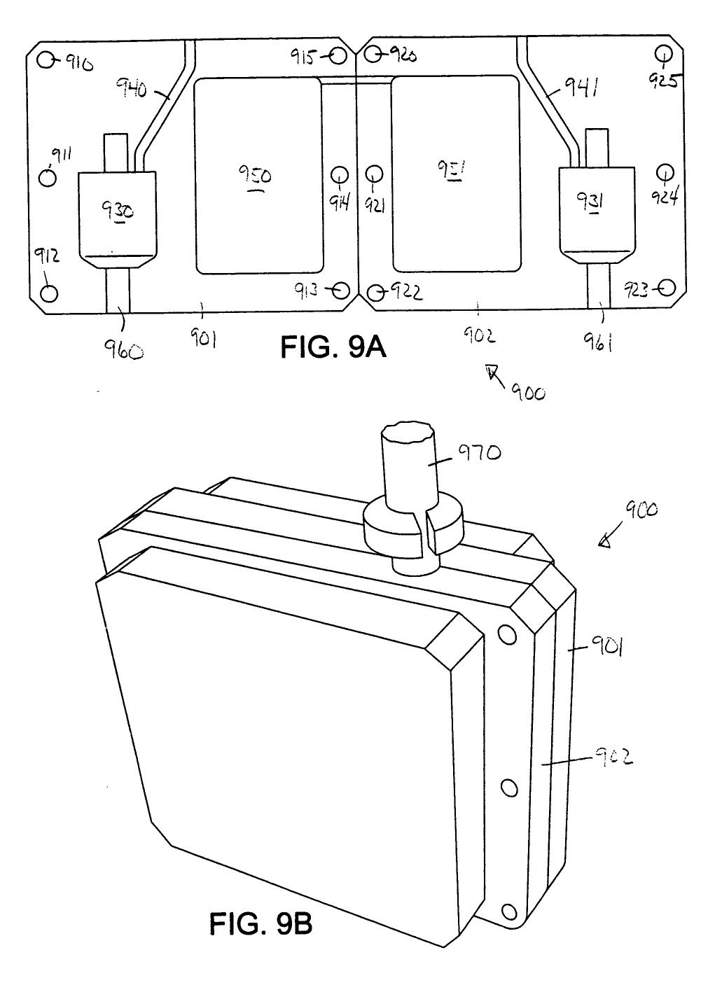

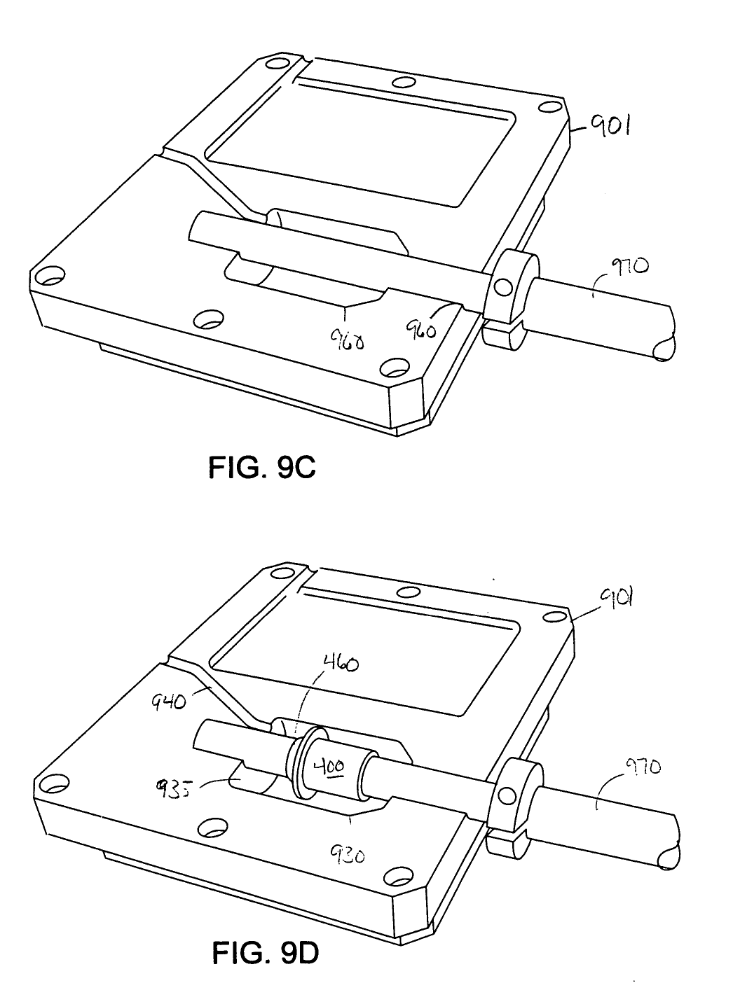

The invention further includes a method for making the bumper according to the invention, which will now be disclosed in conjunction with FIGS. 9A-9D. The method includes using a mold 900, which comprises generally two halves 901 and 902. Half 901 comprises six guide holes 910, 911, 912, 913, 914 and 915 which align and accept guide pins 920, 921, 922, 923, 924 and 925. When the guide pins are inserted into the guide holes, the mold halves 901 and 902 align, as shown in FIG. 9B, and the mold is in the closed position.

The mold 900 has a pair of cavity halves 930 and 931, one on each mold half for forming a bumper therein. A pair of runners 940 and 941 allow for guiding of material into the cavities 930 and 931 when the mold is put together. A pair of spare cavities 950 and 951 can be used at a later time.

A loader bar slot 960 and 961 in each mold half 901 and 902 allows for a loader bar 970 to be laid therein during the molding process. As shown in FIG. 9C, the loader bar 970 is placed into the loader bar slot 960 in the half 901. Note the loader bar 970 extends across the cavity 930 and fits into the loader bar slot 960 on both sides of the cavity.

In operation, the process beings by placing the TPU insert 400 onto the loader bar 970, as shown in FIG. 9D. The inner diameter of the insert 400 is the same as or slightly larger than the diameter of the loader bar 970. The closeness of the diameters prevents material from being molded into the inner area of the insert 400. The loader bar 970 is then placed into the loader bar slot 960 in the mold half 901, with the insert 400 being slid along the loader bar so that the insert is located inside the cavity 930. Preferably, but not required, the insert 400 is slid so that the end 460 of the insert abuts a bottom 935 of the cavity 930 (arrangement not shown).

Once the loader bar 970 with the insert is in place in mold half 901, the second mold half 902 is placed onto mold half 901. The loader bar 970 will stick out of the mold as shown in FIG. 9B.

Away from the mold, the materials used to make the microcellular urethane bumper are mixed, such as the prepolymer and a polyal. Examples of such materials are the Autothane 5000 prepolymer and A5504 polyal, sold by Hyperlast Limited, noted above. These materials are mixed outside the mold and then injected into the runner of the assembled mold. The materials travel through the runner into the cavities 930 and 931 and surround the insert 400 and the loader bar 970. Following the process for curing the combination of materials, the combination will become the microcellular urethane and form the bumper having the insert mounted therein.

Following curing, the mold is then pulled apart at the halves 901 and 902. The loader bar 970 is removed and the bumper is slid off from the loader bar. Then a bumper 500, as shown in FIG. 5, having an insert 400 mounted therein is created and can either be a free standing bumper assembly or be mounted in rigid or flexible cups as described above.

The foregoing describes embodiments of a bumper assembly that is placed between a couple of components to absorb the shock and energy therebetween. However, it should be noted that other embodiments of the present invention, and obvious modifications to those skilled in the art are possible without departing from the scope of the present invention. For example, the bumper assembly could be used in a strut assembly wherein the rod or shaft of the strut passes through the center of the bumper assembly, which prevents the strut assembly from “bottoming out” or when the cylinder of the strut impacts a component of the vehicle. The bumper assembly would provide a cushion to prevent this impact. The bumper assembly could also be used in other situations where it is desired for two objects to not meet at a hard impact.

From the foregoing description, it is evident that there are other changes, modifications or alterations that can come within the province of a person having ordinary skill in the art. It is evident that any such changes, modifications or alterations are specifically included in this description and this invention should only be limited by the claims following hereinafter.

1. A jounce bumper for a wheel suspension system of a vehicle including a first member and a second member displaceable relative to the first member along a line of travel, comprising:
a compressible member disposed between said first and second member along the line of travel; and
an insert disposed inside the first member along the line of travel;
wherein upon application of a force along the line of travel between the first and second member, the compressible member collapses around the insert.

2. The jounce bumper assembly according to claim 1 wherein the insert is a flexible thermoplastic urethane.

3. The jounce bumper assembly according to claim 1 wherein the insert has a cylindrical shape.

4. The jounce bumper assembly according to claim 3 wherein the insert has a longitudinal hole therein collinear with the line of travel.

5. The jounce bumper assembly according to claim 4 wherein the compressible member has a hole extending therethrough collinear with the hole of the insert and the line of travel.

6. The jounce bumper assembly according to claim 5 wherein the bumper assembly is mounted onto a strut assembly.

7. The jounce bumper assembly according to claim 6 wherein a rod of the strut assembly passing through the holes of the compressible member and insert.

8. The jounce bumper assembly according to claim 7 wherein the first member is one of a cylinder of the strut assembly and a portion of the strut assembly and the second member is the other of the cylinder and the portion of the suspension.

9. The jounce bumper assembly according to claim 3 wherein the insert has an annular flange extending from an outer surface thereof.

10. The jounce bumper assembly according to claim 1 wherein the insert is mounted in the compressible member at a lower portion thereof.

11. The jounce bumper assembly according to claim 1 wherein the insert is embedded in the compressible member.

12. The jounce bumper assembly according to claim 1 further comprising a cup disposed between said first and second member along the line of travel having a recess portion and an annular portion surrounding said recess portion.

13. The jounce bumper assembly according to claim 12 wherein a portion of the compressible member is disposed in the recess.

14. The jounce bumper assembly according to claim 13 wherein the recess of the cup and the portion of the compressible member are provided with complimentary, arcuate surfaces.

15. The jounce bumper assembly according to claim 13 wherein the cup is made of a rigid material.

16. The jounce bumper assembly according to claim 13 wherein the cup is made of a flexible material.

17. The jounce bumper assembly according to claim 16 wherein the cup is a thermoplastic urethane.

18. The jounce bumper assembly according to claim 16 wherein upon application of the force along the line of travel, the compressible member collapses into said recess causing said annular portion to expand radially.

19. The jounce bumper assembly according to claim 1 wherein the compressible member is a microcellular urethane.

20. A method for making the jounce bumper assembly according to claim 1, including the following steps:
placing the insert into a cavity of a mold; and
inserting compressible material into the cavity around the insert to form the compressible member.

21. The method according to claim 20 further including inserting a loader bar through a hole in the insert, the combination of which is placed into the mold.

22. The method according to claim 21 wherein the step of inserting includes inserting the compressible material around the insert and the loader bar, the loader bar forming a hold through the center of the compressible member and the insert.

23. The method according to claim 20 further including positioning the combination of the compressible member and insert into a cup.

24. An energy absorption device insertable between a first member and a second member displaceable with respect to each other along a line of travel, said device comprising:
a compressible member disposed between said first and second member along the line of travel; and
an insert embedded inside the first member along the line of travel;
wherein upon application of a force along the line of travel between the first and second member, the compressible member collapses around the insert.

25. The energy absorption device according to claim 24 wherein the insert is positioned at a lower portion of the compressible member.

26. The energy absorption device according to claim 24 wherein the device has a hole extending along the line of travel through the compressible member and the insert.

27. The energy absorption device according to claim 24 wherein the insert has a generally cylindrical shape.

28. The energy absorption device according to claim 25 wherein the insert has an annular flange on an outer wall thereof.

29. The energy absorption device according to claim 24 further comprising a cup into which a portion of the compressible member is positioned.
